(19) United States
(12) Patent Application Publication
(10) Pub. No.: US 2026/0219808 A1
(43) Pub. Date: Jul. 30, 2026

(54) MEMORY SYSTEMS, METHODS OF OPERATING MEMORY SYSTEMS, MEMORY DEVICES, AND MEMORY CONTROLLERS

(71) Applicant: YANGTZE MEMORY TECHNOLOGIES CO., LTD., Wuhan (CN)

(72) Inventor: Tao XIONG, Wuhan (CN)

(21) Appl. No.: 19/286,915

(22) Filed: Jul. 31, 2025

(30) Foreign Application Priority Data
Jan. 24, 2025 (CN) 2025101209258

(51) Int. Cl. G06F 3/06

(52) U.S. Cl. CPC G06F 3/0659; G06F 3/0611; G06F 3/064; G06F 3/0688

(57) ABSTRACT

A memory system includes a memory device and a memory controller, the memory device is coupled with the memory controller, and the memory device includes a plurality of dies, each of the dies includes first physical blocks. The memory controller is configured to, in response to a data write instruction, determine physical blocks of to-be-written data, wherein the number of the physical blocks of the to-be-written data is less than the number of the first physical blocks; and control the memory device to write data to the physical blocks of the to-be-written data according to addresses of the physical blocks of the to-be-written data.

### CROSS-REFERENCE TO RELATED APPLICATIONS

The present disclosure claims priority to Chinese Patent Application No. 2025101209258, which was filed Jan. 24, 2025, and is hereby incorporated herein by reference in its entirety.

### FIELD OF TECHNOLOGY

This disclosure relates to the field of semiconductor chip technologies, and in particular, to a memory system, a method of operating a memory system, a memory device, and a memory controller.

### BACKGROUND

NAND memory devices have characteristics such as data non-volatile, fast reading and writing speed, low power consumption, long service life and the like, and are widely used in various electronic products, such as mobile phones, computers, smart sensors, positioning devices, and the like. When the memory device adopts a multi-step program operation, the memory controller controlling the memory device needs to cache a write buffer with a larger capacity to cache the to-be-written data, and the memory controller needs to have a capacitor with a larger capacitance to perform a power loss protection (PLP) function.

### SUMMARY

According to a first aspect, an example of this disclosure provides a memory system. The memory system includes a memory device and a memory controller, the memory device is coupled with the memory controller, and the memory device includes a plurality of dies, each die includes first physical blocks. The memory controller is configured to, in response to a data write instruction, determine physical blocks of the to-be-written data, wherein the number of physical blocks of the to-be-written data is less than the number of the first physical blocks; and control the memory device to write data to the physical blocks of the to-be-written data according to addresses of the physical blocks of the to-be-written data.

In some possible implementations, the physical blocks of the to-be-written data is located on a portion of the plurality of dies.

In some possible implementations, the memory controller is configured to: in response to a first data write instruction, determine first physical blocks of the to-be-written data in the first physical blocks, wherein the number of the first physical blocks of the to-be-written data is less than the number of the first physical blocks.

In some possible implementations, the memory controller is configured to: control, by chip-selecting the portion of the dies, the memory device to write data to the first physical blocks of the to-be-written data on the portion of the dies according to addresses of the first physical blocks of the to-be-written data.

In some possible implementations, each of the dies further includes second physical blocks; and the memory controller is configured to, in response to a second data write instruction, determine first physical blocks of the to-be-written data in the first physical blocks, and determine second physical blocks of the to-be-written data in the second physical blocks. Therein, a sum of the number of the first physical blocks of the to-be-written data and the number of the second physical blocks of the to-be-written data is less than the number of the first physical blocks.

In some possible implementations, the portion of the dies include a first portion of the dies and a second portion of the dies, and the memory controller is configured to: control, by chip-selecting the first portion of the dies, the memory device to write data to the first physical blocks of the to-be-written data on the first portion of the dies according to addresses of the first physical blocks of the to-be-written data; and control, by chip-selecting the second portion of the dies, the memory device to write data to the second physical blocks of the to-be-written data on the second portion of the dies according to addresses of the second physical blocks of the to-be-written data.

In some possible implementations, block addresses in addresses of the first physical blocks of the to-be-written data is different from block addresses in addresses of the second physical blocks of the to-be-written data.

In some possible implementations, each of the dies further includes second physical blocks and third physical blocks; and the memory controller is configured to: in response to a third data write instruction, determine first physical blocks of the to-be-written data in the first physical blocks, determine second physical blocks of the to-be-written data in the second physical blocks, and determine third physical blocks of the to-be-written data in the third physical blocks. Therein, a sum of the number of the first physical blocks of the to-be-written data, the number of the second physical blocks of the to-be-written data, and the number of the third physical blocks of the to-be-written data is less than the number of the first physical blocks.

In some possible implementations, the portion of the dies includes a first portion of the dies, a second portion of the dies and a third portion of the dies, and the memory controller is configured to: control, by chip-selecting the first portion of the dies, the memory device to write data to the first physical blocks of the to-be-written data on the first portion of the dies according to addresses of the first physical blocks of the to-be-written data; control, by chip-selecting the second portion of the dies, the memory device to write data to the second physical blocks of the to-be-written data on the second portion of the dies according to addresses of the second physical blocks of the to-be-written data; and control, by chip-selecting the third portion of the dies, the memory device to write data to the third physical blocks of the to-be-written data on the third portion of the dies according to addresses of the third physical blocks of the to-be-written data.

In some possible implementations, block addresses in addresses of the first physical blocks of the to-be-written data, block addresses in addresses of the second physical blocks of the to-be-written data, and block addresses in addresses of the third physical blocks of the to-be-written data are different from each other.

In some possible implementations, block addresses in addresses of the physical blocks of the to-be-written data are the same; or, block addresses in addresses of physical blocks of a portion of the to-be-written data are different from block addresses in addresses of physical blocks of the other to-be-written data.

According to a second aspect, an example of this disclosure provides a method of operating a memory system. The memory system includes a memory device, the memory device includes a plurality of dies, and each of the dies includes first physical blocks; the method includes: in response to a data write instruction, determining physical blocks of the to-be-written data, wherein the number of physical blocks of the to-be-written data is less than the number of the first physical blocks; and controlling the memory device to write data to the physical blocks of the to-be-written data according to addresses of the physical blocks of the to-be-written data.

In some possible implementations, the physical blocks of the to-be-written data are located on a portion of the plurality of dies.

In some possible implementations, the determining, in response to the data write instruction, the physical blocks of the to-be-written data includes: in response to a first data write instruction, determining first physical blocks of the to-be-written data in the first physical blocks, wherein the number of the first physical blocks of the to-be-written data is less than the number of the first physical blocks.

In some possible implementations, controlling the memory device to write the data to the physical blocks of the to-be-written data according to addresses of the physical blocks of the to-be-written data includes: controlling, by chip-selecting the portion of the dies, the memory device to write data to the first physical blocks of the to-be-written data on the portion of the dies according to addresses of the first physical blocks of the to-be-written data.

In some possible implementations, each of the dies further includes second physical blocks. In an example, in response to a data write instruction, determining physical blocks of to-be-written data includes: in response to a second data write instruction, determining first physical blocks of the to-be-written data in the first physical blocks, and determining the second physical blocks of the to-be-written data in the second physical blocks. Therein, a sum of the number of the first physical blocks of the to-be-written data and the number of the second physical blocks of the to-be-written data is less than the number of the first physical blocks.

In some possible implementations, the portion of the dies include a first portion of the dies and a second portion of the dies. In an example, controlling the memory device to write the data to the physical blocks of the to-be-written data according to addresses of the physical blocks of the to-be-written data includes: controlling, by chip-selecting the first portion of the dies, the memory device to write data to the first physical blocks of the to-be-written data on the first portion of the dies according to addresses of the first physical blocks of the to-be-written data; and controlling, by chip-selecting the second portion of the dies, the memory device to write data to the second physical blocks of the to-be-written data on the second portion of the dies according to addresses of the second physical blocks of the to-be-written data.

In some possible implementations, block addresses in addresses of the first physical blocks of the to-be-written data is different from block addresses in addresses of the second physical blocks of the to-be-written data.

In some possible implementations, each of the dies further includes second physical blocks and third physical blocks. In an example, in response to a data write instruction, determining physical blocks of to-be-written data includes: in response to a third data write instruction, determining first physical blocks of the to-be-written data in the first physical blocks, determining second physical blocks of the to-be-written data in the second physical blocks, and determining third physical blocks of the to-be-written data in the third physical blocks. Therein, a sum of the number of the first physical blocks of the to-be-written data, the number of the second physical blocks of the to-be-written data, and the number of the third physical blocks of the to-be-written data is less than the number of the first physical blocks.

In some possible implementations, the portion of the dies includes a first portion of the dies, a second portion of the dies and a third portion of the dies. In an example, controlling the memory device to write the data to the physical blocks of the to-be-written data includes according to addresses of the physical blocks of the to-be-written data: controlling, by chip-selecting the first portion of the dies, the memory device to write data to the first physical blocks of the to-be-written data on the first portion of the dies according to addresses of the first physical blocks of the to-be-written data, controlling, by chip-selecting the second portion of the dies, the memory device to write data to the second physical blocks of the to-be-written data on the second portion of the dies according to addresses of the second physical blocks of the to-be-written data; and controlling, by chip-selecting the third portion of the dies, the memory device to write data to the third physical blocks of the to-be-written data on the third portion of the dies according to addresses of the third physical blocks of the to-be-written data.

In some possible implementations, block addresses in addresses of the first physical blocks of the to-be-written data, block addresses in addresses of the second physical blocks of the to-be-written data, and block addresses in addresses of the third physical blocks of the to-be-written data are different from each other.

In some possible implementations, block addresses in addresses of the physical blocks of the to-be-written data are the same; or, block addresses in addresses of physical blocks of a portion of the to-be-written data are different from block addresses in addresses of physical blocks of the other to-be-written data.

According to a third aspect, an example of this disclosure provides a memory device. The memory device is coupled with the memory controller, and the memory device includes a plurality of dies, each of the dies includes first physical blocks. The memory device is configured to receive a program operation instruction of the memory controller, wherein the program operation instruction includes addresses of physical blocks of the to-be-written data; in response to the program operation instruction, write data to the physical blocks of the to-be-written data, wherein the number of the physical blocks of the to-be-written data is less than the number of the first physical blocks.

In some possible implementations, the physical blocks of the to-be-written data is located on portion of the plurality of dies.

According to a fourth aspect, an example of this disclosure provides a memory controller. The memory controller includes a processing circuit, a first interface circuit and a second interface circuit, and the first interface circuit and the second interface circuit are respectively coupled with the processing circuit. The processing circuit is configured to: receive a data write instruction through the first interface circuit; and in response to the data write instruction, control the memory device to write data to the physical blocks of the to-be-written data through the second interface circuit. Therein, the memory device includes a plurality of dies, each of the dies includes the first physical blocks, and the number of the physical blocks of the to-be-written data is less than the number of the first physical blocks.

According to a fifth aspect, an example of this disclosure provides a computer-readable storage medium, wherein the computer-readable storage medium stores computer-executable instructions; and after the computer-executable instructions are executed, the method in the second aspect can be implemented.

According to a sixth aspect, an example of this disclosure provides a computer device, including a processor, and a readable storage medium coupled to the processor, wherein the readable storage medium stores executable instructions, and when the executable instructions are executed by the processor, the method in the second aspect may be implemented

### BRIEF DESCRIPTION OF THE DRAWINGS

In order to more clearly illustrate the technical solutions in this disclosure, the accompanying drawings required to be used in some examples of this disclosure are briefly described below, and obviously, the drawings in the following description are merely drawings of some examples of the present disclosure, and other drawings may be obtained by those skilled in the art based on these drawings. In addition, the drawings in the following description may be regarded as schematic diagrams, and do not limit the actual size of the product, the actual flow of the method, the actual timing of the signal, and the like in the examples of this disclosure.

FIG. 1 is a schematic structural diagram of a memory system according to an example of this disclosure.

FIG. 2 is a schematic structural diagram of a physical block according to an example of this disclosure.

FIG. 3 is a schematic partial cross-sectional view of a memory string according to an example of this disclosure.

FIG. 4 is a schematic diagram of division of a physical super block according to an example of this disclosure.

FIG. 5 is a schematic diagram of a threshold voltage distribution region of a memory cell in each memory mode according to an example of this disclosure.

FIG. 6 is a schematic flowchart of a method of operating a memory system according to an example of this disclosure.

FIG. 7 is a schematic structural diagram of a physical block address according to an example of this disclosure.

FIG. 8 is a schematic diagram of a mapping relationship between a logical superblock and a physical superblock according to an example of this disclosure.

FIG. 9 is a schematic diagram of a connection between a plurality of dies and a memory controller through a data channel according to an example of this disclosure.

FIG. 10 is a schematic diagram of a mapping relationship between a logical superblock and a physical superblock according to an example of this disclosure.

FIG. 11 is a schematic diagram of interaction between addresses of the physical blocks sent by a memory controller to a memory device in response to a first data write instruction according to an example of this disclosure.

FIG. 12 is a schematic diagram of interaction between addresses of the physical blocks sent by a memory controller to a memory device in response to a second data write instruction according to an example of this disclosure.

FIG. 13 is a schematic diagram of interaction between addresses of the physical blocks sent by a memory controller to a memory device in response to a fourth data write instruction according to an example of this disclosure.

FIG. 14 is a schematic structural diagram of a memory device according to an example of this disclosure.

FIG. 15 is a schematic diagram of a connection structure between a peripheral circuit and a memory array according to an example of this disclosure.

FIG. 16 is a schematic structural diagram of a memory controller according to an example of this disclosure.

### DETAILED DESCRIPTION

The technical solutions in some examples of this disclosure are clearly and completely described below with reference to the accompanying drawings, and it is obvious that the described examples are only a part of the examples of this disclosure, and are not all examples. All other examples obtained by those skilled in the art based on the examples provided in this disclosure fall within the protection scope of this disclosure.

Unless the context requires otherwise, in the entire specification and claims, the term “include” is interpreted as open, inclusive, meaning “including, but not limited to”. In the description of the specification, the terms “one example,” “some examples,” “exemplary example,” “exemplary,” or “some examples,” and the like are intended to indicate that a particular feature, structure, material, or characteristic associated with the implementation or example is included in at least one implementation or example of the present disclosure. The schematic representation of the above terms does not necessarily refer to the same implementation or example. Further, particular features, structures, materials, or characteristics may be included in any suitable manner in any one or more implementations or examples.

The terms “first” and “second” are used for descriptive purposes only and are not to be construed as indicating or implying relative importance or implicitly indicating the number of indicated technical features. Thus, features defining “first”, “second” may explicitly or implicitly include one or more of the features. In the description of the examples of this disclosure, unless otherwise indicated, the meaning of “a plurality of” is two or more.

In describing some examples, expressions of “coupled” and “connected” and their derivatives may be used. For example, the term “connection” may be used in describing some examples to indicate that two or more components are in direct physical contact or electrical contact with each other. As another example, the term “coupled” may be used in describing some examples to indicate that two or more components have direct physical contact or electrical contact. However, the term “coupled” may also refer to that two or more components are not in direct contact with each other but still cooperate or interact with each other. The examples disclosed herein are not necessarily limited to the disclosure herein.

The use of “adapted to” or “configured to” herein means an open and inclusive language that does not exclude devices suitable or configured to perform additional tasks or steps.

In addition, use of “based on” means open and inclusive because the process, operation, calculation, or other action “based on” one or more conditions or values may be based on additional conditions or exceeded values in practice.

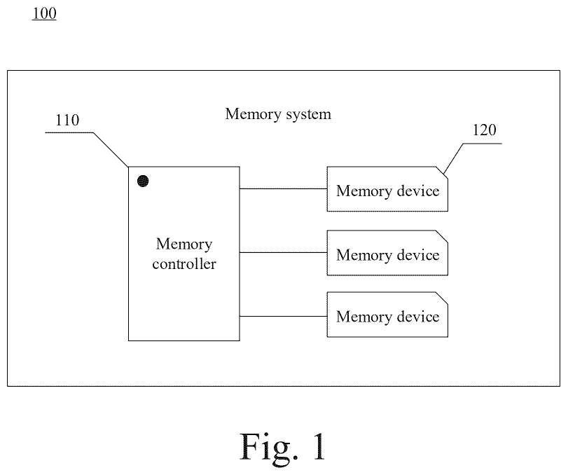

Some examples of this disclosure provide a memory system. As shown in FIG. 1, the memory system 100 includes a memory controller 110 and a memory device 120, and the memory controller 110 is coupled to the memory device 120. In some implementations, the memory controller 110 may be configured to manage data stored in the memory device 120 and communicate with an external device, such as a host. In some implementations, the memory controller 110 may also be configured to control the operation of the memory device 120, such as read, erase, and program operations. In some implementations, the memory controller 110 may also be configured to manage various functions regarding data stored in or to be stored in the memory device 120, including at least one of bad block management, garbage collection, logical-to-physical address translation and wear leveling. In some examples, the memory controller 110 is further configured to process error correction code regarding data read from or written to the memory device 120.

Of course, the memory controller 110 may also perform any other suitable functions. For example, the memory controller 110 formats the memory device 120. For example, the memory controller 110 may also communicate with an external device through at least one of various interface protocols. It should be noted that the interface protocol may be at least one of a universal serial bus (USB) protocol, a multimedia card (MMC) protocol, a peripheral component interconnect (PCI) protocol, a PCI express (PCI-E) protocol, an advanced technology attachment (ATA) protocol, a serial ATA protocol, a parallel ATA protocol, a small computer system interface (SCSI) protocol, an enhanced small disk interface (ESDI) protocol, and an integrated drive electronics (IDE) protocol.

In some implementations, the memory system 100 may be packaged as different types of electronic products. For example, the memory system 100 includes a controller and a memory device 120, and the memory system 100 may be integrated into a memory card. The memory card includes any of a personal computer memory card (PCMCIA card), a compact flash (CF) card, a smart media (SM) card, a memory stick, a multi-media card (MMC), and a secure digital (SD) card. For example, the memory system 100 includes a controller and a plurality of memory devices 120, and the memory system 100 is integrated into a solid state drive (SSD).

In some examples, the memory system 100 may be applied to different types of electronic devices, such as a mobile phone (for example, a cell phone), a desktop computer, a tablet computer, a notebook computer, a server, a vehicle-mounted device, a game console, a printer, a positioning device, a wearable device, a smart sensor, a mobile power supply, a virtual reality (VR) device, an augmented reality (AR) device, and a server, or any electronic device capable of storing data.

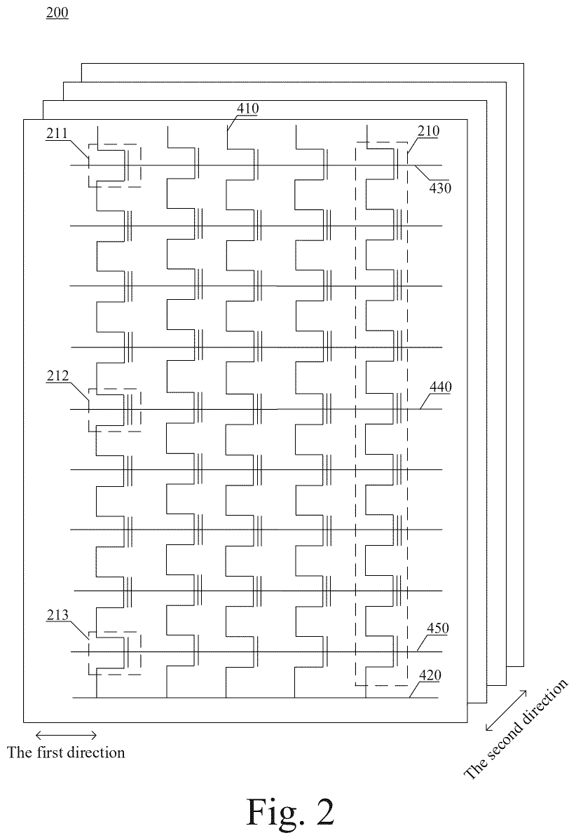

In some implementations, the memory device 120 includes a plurality of dies, each die including a plurality of memory planes, each memory plane including a plurality of physical blocks 200. As shown in FIG. 2, each physical block 200 may include a plurality of memory strings 210, where one end of the memory string 210 is coupled with a bit line (BL) 410, and the other end of the memory string 210 is coupled with a source line (SL) 420. Each memory string 210 may include a top select transistor 211 with a top select gate (TSG), a plurality of memory cells 212, and a bottom select transistor 213 with a bottom select gate (BSG) stacked in series. In some implementations, the memory cell 212 may be a device that can store charge such as a floating gate transistor or a charge trap type field effect transistor and the like.

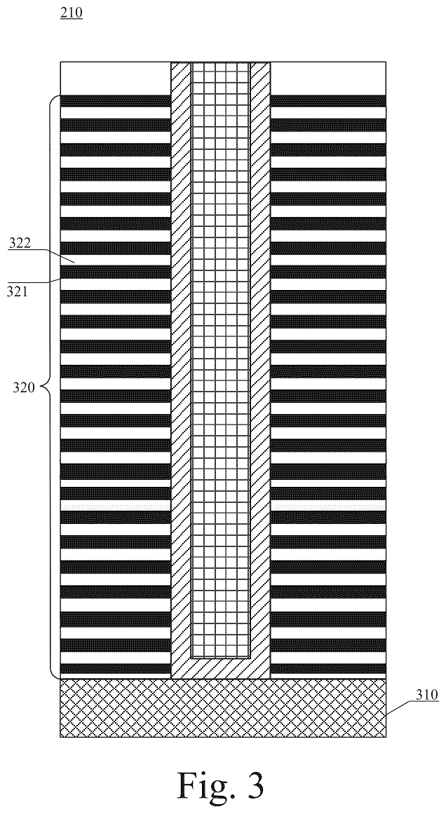

FIG. 3 shows a partial cross-sectional view of a possible memory string 210. The memory string 210 may vertically extend over the semiconductor layer 310. The semiconductor layer 310 may include silicon (e.g., monocrystalline silicon), silicon germanium (SiGe), gallium arsenide (GaAs), germanium (Ge), silicon-on-insulator (SOI), germanium-on-insulator (GOI), or any other suitable material.

The memory string 210 may include a channel structure throughout the stack structure 320, which may include alternating gate conductive layers 321 and dielectric layers 322. The number of the gate conductive layers 321 and the number of the dielectric layers 322 in the stack structure 320 are correlated to the number of the memory cells 212 in the memory string 210.

The gate conductive layer 321 may include a conductive material including, but not limited to, tungsten (W), cobalt (Co), copper (Cu), aluminum (Al), polysilicon, doped silicon, silicide, or any combination thereof. In some implementations, each of the gate conductive layers 321 includes a metal layer, such as a tungsten layer. In some implementations, each gate conductive layer 321 includes a doped polysilicon layer. Each of the gate conductive layers 321 may include a control gate surrounding the memory cell 212, and the gate conductive layer 321 at the top of the stack structure 320 may extend laterally and couple with a top select line (TSL) 430, the gate conductive layer 321 at the bottom of the stack structure 320 may extend laterally and couple with a bottom select line (BSL) 450, or the gate conductive layer 321 between the top select line 430 and the bottom select line 450 may extend laterally and couple with a word line (WL) 440.

Although not shown in FIG. 3, additional features of the memory string 210 may be formed including, but not limited to, gate line slot/source contacts, local contacts, interconnect layers, and the like.

With continued reference to FIG. 2, the memory string 210 may be arranged in a row along a first direction, and the plurality of rows of memory strings 210 may be arranged as physical blocks 200 along a second direction perpendicular to the first direction. In some examples, in the same row of memory strings 210, the gates of the top select transistors 211 of each memory string 210 may be coupled to the same top select line 430; in some examples, the gates of the top select transistors 211 of portions of rows of memory strings 210 in the plurality of rows of memory strings 210 may be coupled to the same top select line 430; the gates of the top select transistors 211 coupled to the same top select line 430 may constitute memory slices. The gates of the bottom select transistors 213 in each memory string 210 may be coupled to the same bottom select line 450. In some implementations, the selected memory string 210 may be activated by the top select line 430 and the bottom select line 450 during a read operation, a program operation, and an erase operation.

Each memory string 210 is coupled to the peripheral circuit 510 through a corresponding bit line 410, e.g., the drain of the top select transistor 211 in the memory string 210 is coupled to the bit line 410. In order to reduce the number of bit lines 410, memory strings 210 in any one memory slice may be coupled to the same bit line 410 as memory strings 210 of corresponding locations in other memory slices.

For the plurality of memory strings 210 in the physical block 200, the control gates of the memory cells 212 in any one memory string 210 and the control gates of the memory cells 212 in corresponding locations in the other memory strings 210 may be coupled to the same word line 440. A source of the bottom select transistor 213 in the memory string 210 may be coupled to a source line 420 (or a common source line (CSL)).

It should be noted that the drawings of the present disclosure only illustrate the example structure of the physical block 200 of some examples, but in practice, the structure of the physical block 200 may also be other manners.

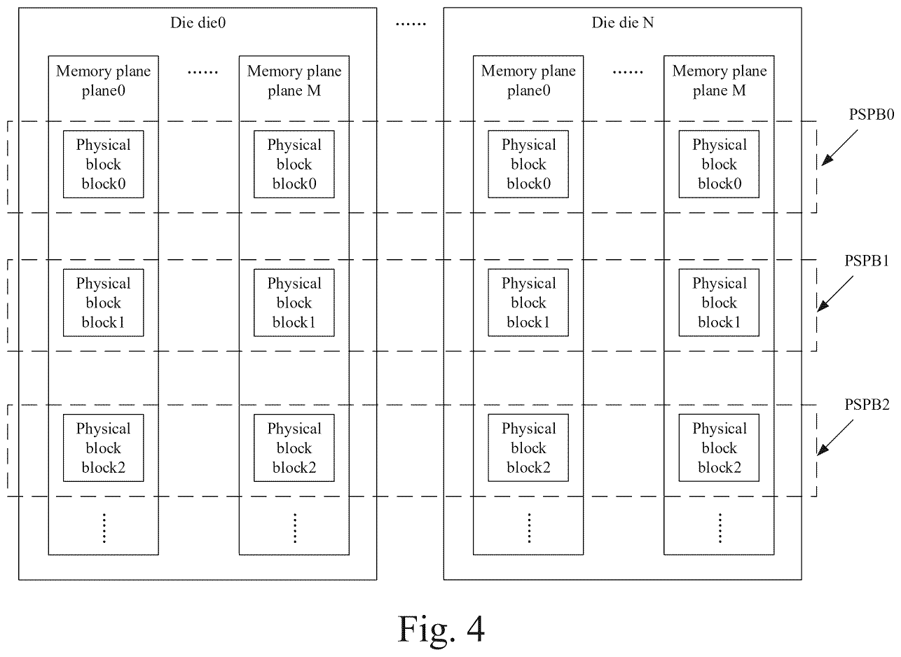

As shown in FIG. 4, in some examples, the memory device 120 includes dies, die0-N, each die includes memory planes, plane0-M, and each memory plane includes a plurality of physical blocks with different block addresses such as physical blocks, block0, block1, and block2. For example, the memory device 120 includes a plurality of physical blocks, block0, a plurality of physical blocks, block1, and a plurality of physical blocks, block2, located on different memory planes. Therein, the number of physical blocks, block0, the number of physical blocks, block1, and the number of physical blocks, block2, are determined by the number of dies and the number of memory planes included in a single die; for example, the number of physical blocks, block0, is equal to the number of dies multiplied by the number of memory planes included in a single die (e.g., N×M); and the number of physical blocks, block1, is equal to the number of physical blocks, block0, and the number of physical blocks, block2, is also equal to the number of physical blocks, block0.

In some implementations, the plurality of physical blocks 200 located on different memory planes may constitute a physical super block (PSPB). For example, as shown in FIG. 4, the plurality of physical blocks, block0, may constitute a physical superblock PSPB0 the plurality of physical blocks, block1, may constitute a physical superblock PSPB1 and the plurality of physical blocks, block2, may constitute a physical superblock PSPB2. The memory controller 110 may control the memory device 120 to perform operations in parallel on the plurality of physical blocks 200 in the physical superblock in response to the received data write instruction, so as to increase a read speed or a program speed of the memory device 120.

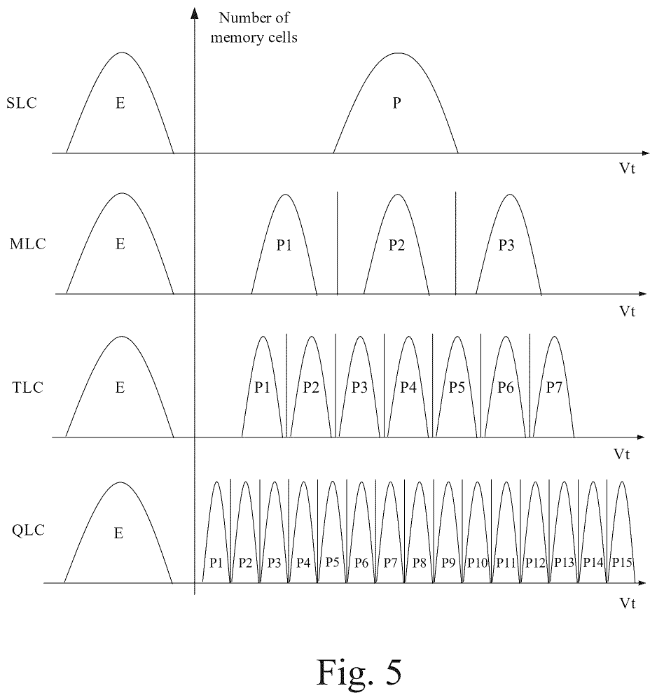

In some implementations, the memory mode of each memory cell 212 in the physical block 200 may include a single-level cell (SLC) and a multi-level cell (MLC). As shown in FIG. 5, the memory cell 212 employing the single-level cell memory mode may store one bit (e.g., 1 bit) and may have two states; namely, one erase (E) state and one program (P) state. The memory cell 212 employing the multi-level cell memory mode may store two bits (e.g., 2 bits) or more and may have four or more states. In some examples, the memory cell 212 may employ a two-level cell memory mode, each memory cell 212 may store two bits and may have four states; for example, three program states (e.g., P1 state, P2 state, and P3 state in FIG. 5) and one erase state (e.g., E state in FIG. 5). In some examples, the memory cell 212 may also employ a triple-level cell (TLC) memory mode, each memory cell 212 may store three bits and may have eight states; for example, seven program states (e.g., P1 state, P2 state, P3 state, P4 state, P5 state, P6 state, and P7 state in FIG. 5) and one erase state (e.g., E state in FIG. 5). In some examples, the memory cell 212 may also employ a quad-level cell (QLC) memory mode, each memory cell 212 may store four bits and may have sixteen states; for example, fifteen program states (e.g., P1-P15 state in FIG. 5) and one erase state (e.g., E state in FIG. 5). In some examples, each state of the memory cell 212 has a one-to-one corresponding threshold voltage distribution region.

As shown in FIG. 5, as the number of bits stored in each memory cell 212 increases, the threshold voltage distribution region corresponding to each program state is gradually narrowed. When the threshold voltage distribution region of the memory cell 212 is gradually narrowed, the memory device 120 needs to optimize the program performance to ensure that the threshold voltage of the memory cell 212 can be accurately set to a desired threshold voltage distribution region. In some implementations, the memory device 120 may employ a multi-step program operation to optimize program performance. The multi-step program operation includes at least a first program operation for coarsely setting the threshold voltage of the memory cell 212 and a second program operation for accurately setting the threshold voltage of the memory cell 212. In some examples, the memory device 120 first performs a first program operation on the memory cell 212 coupled to the word line WLn, and then performs a second program operation on the memory cell 212 coupled to the word line WLn at least after performing the first program operation on the memory cell 212 coupled to the word line WLn+1.

After performing the second program operation on the memory cell 212 coupled to the word line WLn, the data buffered in the memory controller 110 that needs to be written into the memory cell 212 coupled to the word line WLn can be released, so that the memory controller 110 needs to buffer more data. Therefore, in one aspect, the memory controller 110 needs to cache a write buffer with a larger capacity to cache the to-be-written data to the memory device 120, and on the other hand, the memory controller 110 requires a built-in capacitor with a larger capacitance to perform the power loss protection function, these built-in capacitors are charged during normal operation, a brief power supply can be provided when the power supply is turned off, and it is ensured that the memory system 100 has enough time to securely write the data cached in the write buffer into the memory device 120. A write buffer with a larger buffer capacity usually has a larger volume for buffering more data; and a capacitor with a larger capacitance usually has a larger volume for storing more charges, thereby making the design of the circuit board more difficult.

In order to reduce the requirements of the memory controller 110 on the write buffer and the built-in capacitor, the memory controller 110 provided in this implementation of this disclosure is configured to, in response to the data write instruction, determine physical blocks of the to-be-written data, where a number of physical blocks of the to-be-written data is less than a number of physical blocks included in any physical superblock. The memory device 120 is controlled to write data to the physical blocks of the to-be-written data according to addresses of the physical blocks of the to-be-written data.

In the implementations of this disclosure, when performing data parallel writing, the number of physical blocks of the to-be-written data is less than the number of the plurality of physical blocks 200 included in the physical super block. As such, the amount of data written each time can be reduced, so that the requirement of the memory controller 110 on the write buffer is remarkably reduced, and thus the requirement of the built-in capacitor for performing the power loss protection function is reduced, and thus the design difficulty of the circuit board is reduced.

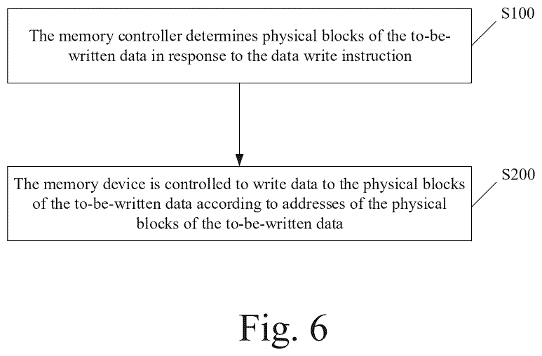

Implementations of this disclosure further provide a method of operating a memory system. As shown in FIG. 6, the method includes S100-S200, as follows:
S100: the memory controller determines physical blocks of the to-be-written data in response to the data write instruction.

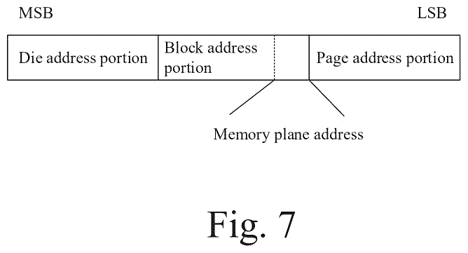

In some implementations, the memory system 100 provides a memory space for the host in a form of logical blocks, and the data write instruction sent by the host may include a logical block address (LBA) of one or more logical blocks, and a plurality of logical blocks may be referred to as a logical super block. The memory controller 110 uses a flash translation layer (FTL) to implement mapping between a logical block address and a physical block address (PBA). In some examples, the memory controller 110 may also implement address mapping using an intermediate address form. For example, the address of the logical block is mapped to the intermediate address, and then the intermediate address is further mapped to the address of the physical block. As shown in FIG. 7, in some implementations, the physical block address may include a die address portion, a block address portion, and a page address portion. The die address portion is located at a most significant bit (MSB), the page address portion is located at a least significant bit (LSB), and the least significant bit in the block address portion is a memory plane address. In the implementations of this disclosure, the physical block address includes at least a die address portion and a block address portion.

In some implementations, the flash translation layer may be configured to generate a logical to physical (L2P) table and the L2P table is sent to a dynamic random access memory (DRAM) located in the memory controller 110. In some implementations, the flash translation layer may also send the L2P table to memory cells located in the memory device 120. In some implementations, the flash translation layer may also be configured to receive instructions from the host and perform any suitable tasks, such as garbage collection, wear leveling, read disturb control, data retention control, bad block management, and the like. The host may implement the storage, expansion, and deletion operations of the data memory device 120 by the flash translation layer regardless of the actual location of these data on the memory device 120.

In the examples provided in this implementation of this disclosure, the memory controller 110 determines, in response to the data write instruction, the addresses of a plurality of physical blocks in the memory device 120 according to the addresses of a plurality of logical blocks in the data write instruction, where the addresses of the plurality of physical blocks may determine the physical blocks of the to-be-written data, and the number of physical blocks of the to-be-written data is less than the number of the first physical blocks, where the first physical blocks may be the physical blocks, block0. As described above, the number of physical blocks, block0, is equal to the number of physical blocks, block1, which is equal to the number of physical blocks, block2. Also, the plurality of physical blocks, block0, may constitute a physical superblock PSPB0, the plurality of physical blocks, block1, may constitute a physical superblock PSPB1, and the plurality of physical blocks, block2, may constitute a physical superblock PSPB2. For example, in the implementation of this disclosure, the number of physical blocks of the to-be-written data determined by the memory controller 110 each time in response to the data write instruction is less than the number of physical blocks 200 included in a physical superblock.

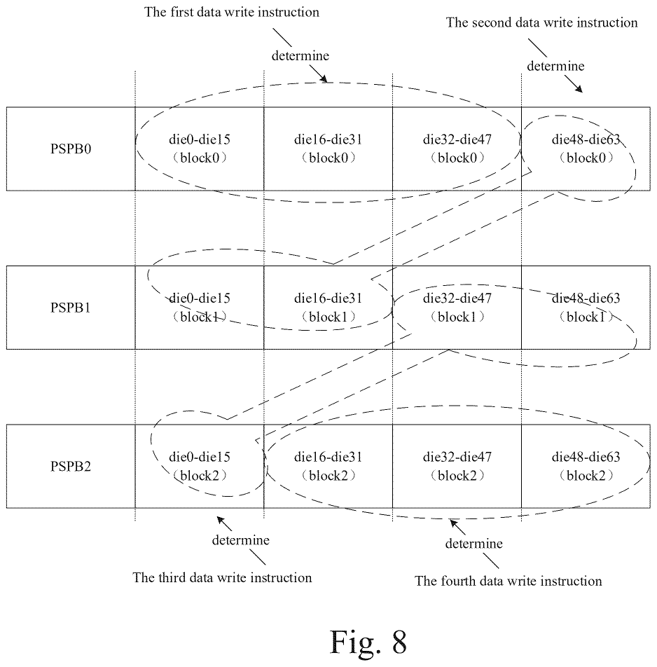

In some implementations, the physical blocks of the to-be-written data is located on some of the plurality of dies. For ease of understanding this disclosure, the memory device 120 includes dies, die0-63, each die includes memory planes, plane0-7, and each memory plane includes physical blocks, block0 (physical blocks, block0, are the first physical blocks), physical blocks, block1 (physical blocks, block1, are the second physical blocks), and physical blocks, block2 (physical blocks block2 are the third physical blocks) as an example for description. As shown in FIG. 8, the physical blocks, block0, on the dies, die0-63, may constitute a physical superblock PSPB0, the physical blocks, block1, on the dies, die0-63, may constitute the physical superblock PSPB1, and the physical blocks, block2, on the dies, die0-63, may constitute the physical superblock PSPB2.

In some implementations, in response to the first data write instruction sent by the host, the memory controller 110 determines that the physical blocks, block0, of the portion in the physical superblock PSPB0 are the physical blocks, block0, of the to-be-written data. For example, as shown in FIG. 8, in response to the first data write instruction, the memory controller 110 determines that the physical blocks, block0, on the dies, die0-47 are the physical blocks, block0, of the to-be-written data. It can be seen that the dies, die0-47, are part of the dies, die0-63, and the number of the physical blocks, block0, of the to-be-written data (e.g., the physical blocks, block0, on the dies, die0-47) are less than the number of the physical blocks, block0 (the physical blocks, block0, on the dies, die0-63) included in the physical superblock PSPB0.

In some implementations, in response to a second data write instruction sent by the host, the memory controller 110 determines that a portion of the physical blocks, block0, are the physical blocks, block0, of the to-be-written data in the physical superblock PSPB0 and determines that a portion of the physical blocks, block1, are the physical blocks, block1, of the to-be-written data in the physical superblock PSPB1. For example, as shown in FIG. 8, in response to the second data write instruction, the memory controller 110 determines that the physical blocks, block0, on the dies, die48-63, are the physical blocks, block0, of the to-be-written data, and determines that the physical blocks, block1, on the dies, die0-31, are the physical blocks, block1, of the to-be-written data. It can be seen that the sum of the dies, die48-63, and the dies, die0-31 is also part of the dies, die0-63, and the sum of the number of physical blocks, block0, of the to-be-written data (e.g., the physical blocks, block0, on the dies, die48-63) and the number of the physical blocks, block1, of the to-be-written data (e.g., the physical blocks, block1, on the dies, die0-die31) is also less than the number of the physical blocks, block0 (the physical blocks, block0, on the dies, die0-63) included in the physical superblock PSPB0.

In some implementations, in response to a third data write instruction sent by the host, the memory controller 110 determines that a portion of physical blocks, block1, are the physical blocks, block1, of the to-be-written data in the physical superblock PSPB1 and determines that the physical blocks, block2, of the portion are the physical blocks, block2, of the to-be-written data in the physical superblock PSPB2. For example, as shown in FIG. 8, in response to the third data write instruction, the memory controller 110 determines that the physical blocks, block1, on the dies, die32-63, are the physical blocks, block1, of the to-be-written data, and determines that the physical blocks, block2, on the dies, die0-15 are the physical blocks, block2, of the to-be-written data. It can be seen that the sum of the dies, die32-63, and the dies, die0-15, is also part of the dies, die0-63, and the sum of the number of physical blocks, block1, of the to-be-written data (e.g., the physical blocks, block1, on the dies, die32-63) and the number of the physical blocks, block2, of the to-be-written data (e.g., the physical blocks, block2, on the dies, die0-15) is also less than the number of the physical blocks, block0 (the physical blocks, block0, on the dies, die0-63), included in the physical superblock PSPB0.

In some implementations, in response to the fourth data write instruction sent by the host, the memory controller 110 determines that a portion of the physical blocks, block2, determined in the physical superblock PSPB2 are the physical blocks, block2, of the to-be-written data. For example, as shown in FIG. 8, in response to the first data write instruction, the memory controller 110 determines that the physical blocks, block2, on the dies, die16-63, are the physical blocks, block2, of the to-be-written data. It can be seen that the dies, die16-63, are part of the dies, die0-63, and the number of physical blocks, block2, of the to-be-written data (e.g., the physical blocks, block2, on the dies, die 16-63) is less than the number of physical blocks, block0 (physical blocks, block0, on the dies, die0-63) included in the physical superblock PSPB0.

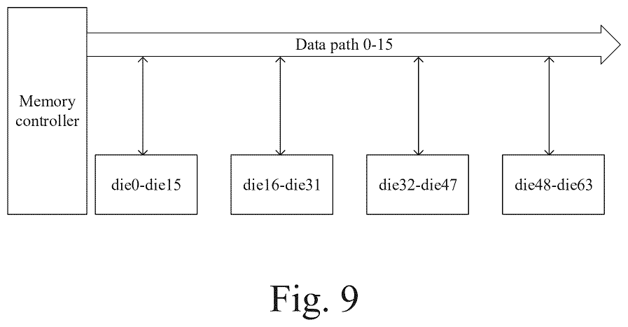

As shown in FIG. 9, in some implementations, in order to ensure the efficiency of the data channel, the memory controller 110 causes the die to which the logical superblock is mapped to uniformly occupy the used data channel. For example, the dies, die0-15, respectively occupy 16 data channels, the dies, die16 to die31, the dies, die32-47, and the dies, die48-63, also respectively multiplex the 16 data channels. Thus, the dies, die 0-47, the dies, die 48-31, the dies, die 31-15, and the dies, die16-63, can occupy the used data channels uniformly.

In some implementations, the memory controller 110 may implement the mapping of the logical blocks to the physical blocks according to a preset mapping function. An implementation of this disclosure provides an example expression of a mapping function, where an input parameter of the mapping function is (nX, nIdx), and represents an nIdxth logical block on the nXth logical superblock, where 0≤nIdx≤384. The output parameter is (pX, pIdx), which represents pIdxth physical block on the pXth physical superblock, where 0≤nIdx≤512.

First, M=nX/4, N=nX % 4, K=3×M are defined. For example, when nX=0, M=0, N=0, and K=0; when nX=1, M=0, N=1, and K=0; when nX=2, M=0, N=2, and K=0; when nX=3, M=0, N=3, and K=0; when nX=4, M=1, N=0, K=3, the mapping function is as follows:

When N=0, pX=K, pIdx=nIdx. In some examples, the function may map 384 logical blocks in the logical superblock LSBP0 to the first 384 physical blocks in the physical superblock PSPB0. For example, the logical superblock LSPB0 is mapped to the physical blocks, block0, on the dies, die0-47. In some examples, the function may also map 384 logical blocks in the logical superblock LSBP4 to the first 384 physical blocks in the physical superblock PSPB3. For example, the logical superblock LSPB4 is mapped to the physical blocks, block3, on the dies, die0-47.

When N=1 and nIdx<16×8, pX=K, pIdx=48×8 +nIdx. In some examples, the function may map the first 127 logical blocks in the logical superblock LSBP1 to the 385th physical block through the 512th physical block in the physical superblock PSPB0. When N=1 and nIdx≥16×8, pX=K+1, pIdx=nIdx−16×8. In some examples, the function may map the 128th logical block through the 384th logical block in the logical superblock LSBP1 to the first 256 physical blocks in the physical superblock PSPB1. For example, the logical superblock LSPB1 is mapped to the physical blocks, block0, on the dies, die48-63, and to the physical blocks, block1, on the dies, die0-31.

When N=2 and nIdx<32×8, pX=K+1, pIdx=32×8+nIdx. In some examples, the function may map the first 256 logical blocks in the logical superblock LSBP2 to the 256th physical block to the 512th physical block in the physical superblock PSPB1. When N=2 and nIdx≥32×8, pX=K+2, pIdx=nIdx−32×8. In some examples, the function may map the 257th logical block to the 384th logical block in the logical superblock LSBP2 to the first 128 physical blocks in the physical superblock PSPB2. For example, the logical superblock LSPB3 is mapped to the physical blocks, block1, on the dies, die32-63, and to the physical blocks, block2, on the dies, die0-15.

When N=3, pX=K+2, pIdx=nIdx+16×8. In some examples, the function may map 384 logical blocks in the logical superblock LSBP3 to the 129th physical block through the 512th physical block in the physical superblock PSPB2. For example, the logical superblock LSPB3 is mapped to the physical blocks, block2, on the dies, die16-63.

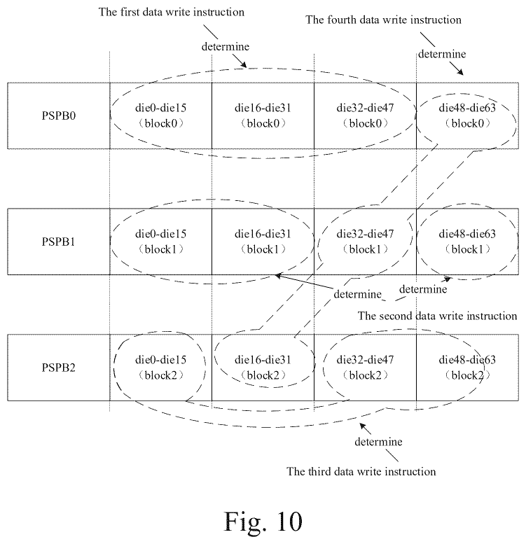

As shown in FIG. 10, in some other implementations, in response to the host sending the first data write instruction, the memory controller 110 determines that the physical blocks, block0, on the dies, die0-47 are the physical blocks, block0, of the to-be-written data.

In response to the host sending the second data write instruction, the memory controller 110 determines that the physical blocks, block1, on the dies, die0-31, and the dies, die48-63, are the physical blocks, block1, of the to-be-written data.

In response to the host sending the third data write instruction, the memory controller 110 determines that the physical blocks, block2, on the dies, die0-15 and the dies, die32-63, are the physical blocks, block2, of the to-be-written data.

In response to the host sending the fourth data write instruction, the memory controller 110 determines that the physical blocks, block0, on the dies, die48-63, are the physical blocks, block0, of the to-be-written data, the physical blocks, block1, on the dies, die32-47, are the physical blocks, block1, of the to-be-written data, and the physical blocks, block2, on the dies, die16-31, are the physical blocks, block2, of the to-be-written data.
S200: the memory device is controlled to write data to the physical blocks of the to-be-written data according to addresses of the physical blocks of the to-be-written data.

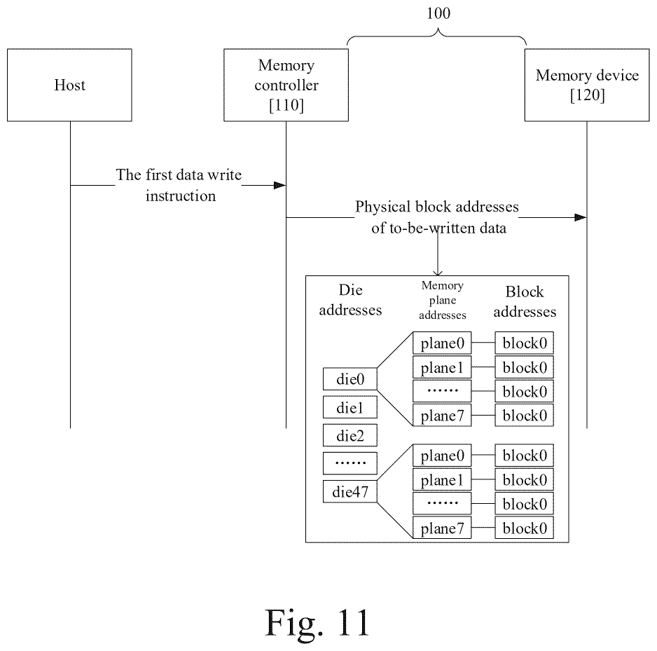

As shown in FIG. 8, in some implementations, in response to the first data write instruction, the memory controller 110 determines that the physical blocks, block0, on the dies, die0-47 are the physical blocks, block0, of the to-be-written data. The memory controller 110 may send the addresses of the physical blocks, block0 (e.g., physical blocks of the to-be-written data), on the dies, die0-47, to the memory device 120. As described above, the addresses of the physical blocks include the die address, the memory plane address, and the block address, as shown in FIG. 11, the block addresses in the addresses of any two physical blocks, block0, of the to-be-written data are the same; for example, the block addresses in the addresses of the physical blocks of the to-be-written data may be the same. In addition, in the addresses of any two physical blocks, block0, of the to-be-written data, at least one of the die addresses and the memory plane addresses are different. For example, for any two physical blocks, block0, of the to-be-written data, there may be the same die address, and different memory plane addresses; or different die addresses, and the same memory plane addresses; or different die addresses, and different memory plane addresses.

In some implementations, the memory controller 110 also chip-selects the dies, die0-47 through the chip-select signal, thereby controlling the memory device 120 to write data to the physical blocks, block0, on the dies, die0-47.

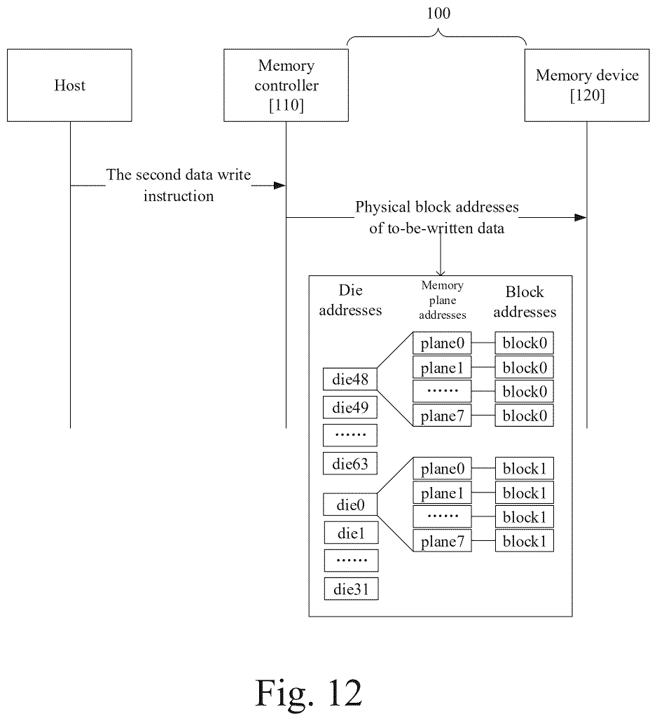

As shown in FIG. 8, in some examples, in response to the second data write instruction, the memory controller 110 determines that the physical blocks, block0, on the dies, die48-63, are the physical blocks, block0, of the to-be-written data, and determines that the physical blocks, block1, on the dies, die0-31 are the physical blocks, block1, of the to-be-written data. The memory controller 110 may send the addresses of the physical blocks, block0, of the to-be-written data and the addresses of the physical blocks, block1, of the to-be-written data to the memory device 120. As shown in FIG. 12, in the addresses of any two physical blocks, block1, of the to-be-written data, the block addresses are the same, and at least one of the die addresses and the memory plane addresses are different. In addition, the block addresses in the addresses of any physical block, block0, of the to-be-written data and an address of any physical block, block1, of the to-be-written data are different; for example, the block addresses in the addresses of a part of the physical blocks (for example, the physical blocks, block0, on the dies, die48-63) of the to-be-written data are different from the block addresses in the addresses of other physical blocks (for example, the physical blocks, block1, on the dies, die0-31) of the to-be-written data. In addition, in the addresses of any physical block, block0, of the to-be-written data and the addresses of any physical block, block1, of the to-be-written data, at least one of the die addresses and the memory plane addresses are different.

In some implementations, the memory controller 110 also chip-selects the first portion of the dies (e.g., the dies, die48-63) by the chip-select signal, thereby controlling the memory device 120 to write data to the physical blocks, block0, on the dies, die0-47; and chip-selects the second portion of the dies (e.g., the dies, die0-31) by the chip-select signal, thereby controlling the memory device 120 to write data to the physical blocks, block1, in the dies, die0-31.

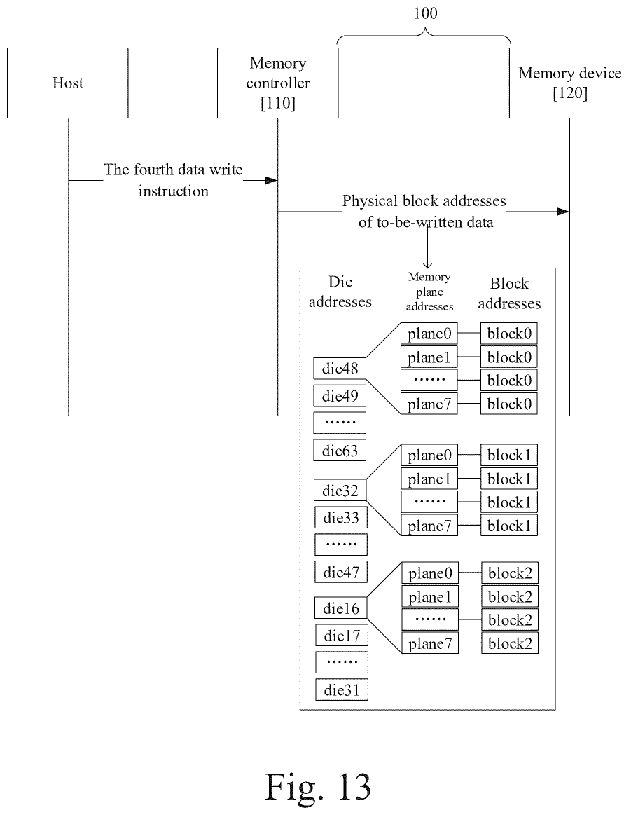

As shown in FIG. 10, in some other implementations, in response to the fourth data write instruction, the memory controller 110 determines that the physical blocks, block0, on the dies, die48-63, are the physical blocks, block0, of the to-be-written data, the physical blocks, block1, on the dies, die32-47, are the physical blocks, block1, of the to-be-written data, and the physical blocks, block2, on the dies, die16-31, are the physical blocks, block2, of the to-be-written data. The memory controller 110 may send the addresses of the physical blocks, block0, of the to-be-written data, the addresses of the physical blocks, block1, of the to-be-written data, and the addresses of the physical blocks, block2, of the to-be-written data to the memory device 120. As shown in FIG. 13, the block addresses in the addresses of any of the physical blocks, block0, of to-be-written data, the block addresses in the addresses of any of the physical blocks, block1, of to-be-written data, and the block addresses in the addresses of any of the physical blocks, block2, of to-be-written data, are different from each other.

In some implementations, the memory controller 110 also chip-selects the first portion of the dies through the chip-select signal; e.g., the dies, die48-63, controls the memory device 120 to write data to the physical blocks, block0, on the dies, die0-47. The second portion of the dies (e.g., the dies, die 32-47) is selected by the chip-select signal; and the memory device 120 is controlled to write data to the physical blocks, block1, on the dies, die 32-47. The third portion of the dies (e.g., the dies, die16-31) is selected by the chip-select signal; and the memory device 120 is controlled to write data to the physical blocks, block2, on the dies, die 16-31.

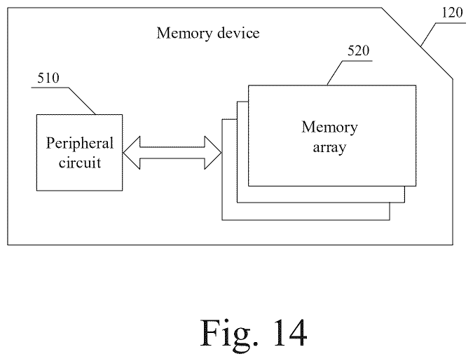

The example of the disclosure provides a memory device. As shown in FIG. 14, the memory device 120 may include a memory array 520 and a peripheral circuit 510, and the memory array 520 is coupled to the peripheral circuit 510. In some examples, the peripheral circuit 510 and the memory array 520 may be formed separately on two wafers using different semiconductor manufacturing processes. In some examples, the memory array 520 may be formed by a mature manufacturing process (e.g., 22 nm, 28 nm, or any manufacturing process above) to ensure the stability of the stored data. The peripheral circuit 510 may be formed by an advanced manufacturing process (e.g., 14 nm, 10 nm, or any of the following processes, etc.), so as to improve the speed at which the memory device 120 reads/stores data. A wafer (which may be referred to as an array wafer) on which the memory array 520 is formed and a wafer (which may be referred to as a coms wafer) on which the peripheral circuit 510 is formed are bonded by a bonding process, so that the peripheral circuit 510 is coupled to the memory array 520.

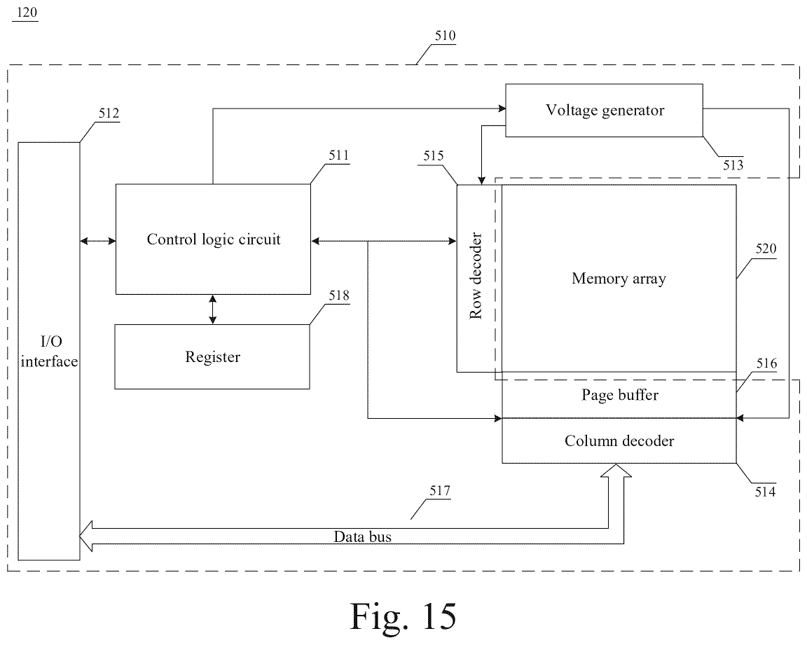

As shown in FIG. 15, in some implementations, the peripheral circuit 510 includes a control logic circuit 511, an I/O interface 512, a voltage generator 513, a column decoder 514, a row decoder 515, a page buffer 516, a data bus 517, and a register 518. In some examples, additional circuits not shown in FIG. 15 may also be included.

The control logic circuit 511 may be coupled to the voltage generator 513, the page buffer 516, the column decoder 514, the row decoder 515, and the I/O interface 512, etc., and configured to control operation of each peripheral circuit 510. The control logic circuit 511 may control the operation of the row decoder 515, the column decoder 514, the page buffer 516, and the voltage generator 513 in response to a command (CMD) or a control signal received by the I/O interface 512 generating an operation signal, where the command may be a program command, a read command, or the like.

The I/O interface 512 may be coupled to the control logic circuit 511 and serve as a control buffer to buffer the received control command and relay it to the control logic circuit 511 and to buffer status information received from the control logic circuit 511 and relay it to the host. The I/O interface 512 may also be coupled to the page buffer 516 via a data bus 517 and serve as a data I/O interface 512 and a data buffer to buffer and relay data to or from the memory array 520.

The voltage generator 513 may use an external supply voltage or an internal supply voltage to generate various voltages for performing operations such as erase, program, read, and verify on the memory array 520, for example, a program voltage Vpgm, an erase voltage Vera and a ground voltage Vss, etc., applied to the word line 440, and combinations thereof.

The column decoder 514 may select one or more memory strings 210 in the memory array 520 in response to the control logic circuit 511 controlling and by applying a bit line 410 voltage generated from the voltage generator 513.

The row decoder 515 may supply the word line 440 voltage generated from the voltage generator 513 to the select word line and the non-select word line of the memory array 520 in response to the control logic circuit 511 controlling. As described in detail above, the row decoder 515 is configured to perform the program operation on the memory cells 212 coupled to one or more select word lines in the memory array 520.

The page buffer 516 is coupled with the memory array 520 through the bit line 410. In some examples, the page buffer 516 may read data from and program (write) data to the memory array 520 according to the control signal from the control logic circuit 511. In other examples, the page buffer 516 may store program data (write data) to be programmed into the memory array 520. In yet other examples, the page buffer 516 may also perform a program verify operation to ensure that the data has been properly programmed into the memory cell 212 coupled to the select word line.

The register 518 may be coupled to the control logic circuit 511 and include status register, command register, and address register for storing the status information, the command operation code (OP code), and the command address for controlling operation of each peripheral circuit 510.

It should be understood by those skilled in the art that the operations performed by the row decoder 515, the page buffer 516, the control logic circuit 511, and the voltage generator 513 described in this disclosure may be performed by the processing circuit. The processing circuit may include, but is not limited to, hardware of a logic circuit or a hardware/software combination of a processor executing software.

In some examples, the memory array 520 includes a plurality of dies, each die includes a plurality of memory planes, and each memory plane includes a first physical block; for example, the number of the first physical blocks is equal to a number of dies multiplied by a number of memory planes included in each die. The peripheral circuit 510 is configured to receive a program operation instruction of the memory controller 110, where the program operation instruction includes addresses of physical blocks of the to-be-written data; in response to the program operation instruction, write data to the physical blocks of the to-be-written data in the memory array 520, where physical blocks of the to-be-written data are located on some of the plurality of dies, and the number of physical blocks of the to-be-written data is less than the number of the first physical blocks.

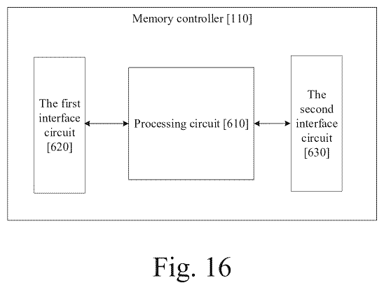

Implementations of the disclosure further provides a memory controller. As shown in FIG. 16, the memory controller 110 includes a processing circuit 610, a first interface circuit 620, and a second interface circuit 630, and the first interface circuit 620 and the second interface circuit 630 are respectively coupled to the processing circuit 610. The processing circuit 610 is configured to: receive a data write instruction through the first interface circuit 620; and in response to the data write instruction, control the memory device 120 to write data to the physical blocks of the to-be-written data through the second interface circuit 630. Therein, the memory device 120 includes a plurality of dies, each of the dies includes the first physical blocks, and a number of the physical blocks of the to-be-written data is less than a number of the first physical blocks.

An example of this disclosure provides a computer-readable storage medium, where the computer-readable storage medium stores computer-executable instructions; and after the computer-executable instructions are executed, method of any one of FIG. 6 and FIGS. 8-13 can be implemented.

An example of this disclosure provides a computer device, including a processor, and a readable storage medium coupled to the processor, where the readable storage medium stores executable instructions, and when the executable instructions are executed by the processor, method of any one of FIG. 6 and FIGS. 8-13 can be implemented.

An implementation of this disclosure provides a memory system, a method of operating the memory system, a memory device, and a memory controller. Therein, when the memory system 100 performs data parallel writing, a number of physical blocks of the to-be-written data is less than a number of a plurality of physical blocks 200 included in a physical super block. As such, the amount of data written each time can be reduced, so that the requirement of the memory controller 110 on the write buffer is remarkably reduced, and thus the requirement of the built-in capacitor for performing the power loss protection function is reduced, and thus the design difficulty of the circuit board is reduced.

It can be clearly understood by those skilled in the art that, for convenience and brevity of description, in the foregoing example, the description of each example has different emphasis. For the part not detailed in an example, the corresponding process in the above example of the method can be referred to and will not be repeated here.

In the several examples provided in this disclosure, the memory system, the method of operating the memory system, and the memory device provided may be implemented in other manners. For example, a division of a certain module is merely a logical function division, and in practice, there may be another division manner. For example, multiple units or components may be combined or may be integrated into another system, or some features may be ignored, or not executed.

Those of ordinary skill in the art will appreciate that the modules and algorithm operations of the examples described in connection with the examples disclosed herein can be implemented in electronic hardware, or in a combination of computer software and electronic hardware. Whether these functions are performed in hardware or software depends on the specific application and the design constraints of the technical solutions. Those skilled in the art may use different methods for each particular application to implement the described functionality, but such implementations should not be considered to be beyond the scope of the present disclosure.

The foregoing is only a specific example of this disclosure, but the protection scope of this disclosure is not limited thereto, and any changes or replacements that can be easily conceived by those skilled in the art within the technical scope disclosed in the present disclosure should be covered within the protection scope of this disclosure. Therefore, the protection scope of this disclosure should be subject to the protection scope of the claims.

What is claimed is:

1. A memory system, comprising:
a memory device including dies, wherein each of the dies comprises first physical blocks; and
a memory controller coupled with the memory device and configured to:
in response to a data write instruction, determine physical blocks of to-be-written data, wherein a number of the physical blocks of the to-be-written data is less than a number of the first physical blocks; and
control the memory device to write data to the physical blocks of the to-be-written data according to addresses of the physical blocks of the to-be-written data.

2. The memory system of claim 1, wherein the physical blocks of the to-be-written data are located on a portion of the dies.

3. The memory system of claim 2, wherein the memory controller is configured to, in response to a first data write instruction, determine first physical blocks of the to-be-written data in the first physical blocks, and wherein the number of the first physical blocks of the to-be-written data is less than the number of the first physical blocks.

4. The memory system of claim 3, wherein the memory controller is configured to control, by chip-selecting the portion of the dies, the memory device to write data to the first physical blocks of the to-be-written data on the portion of the dies according to addresses of the first physical blocks of the to-be-written data.

5. The memory system of claim 2, wherein each of the dies further comprises second physical blocks, and the memory controller is configured to, in response to a second data write instruction, determine first physical blocks of the to-be-written data in the first physical blocks, and determine second physical blocks of the to-be-written data in the second physical blocks, and wherein a sum of the number of the first physical blocks of the to-be-written data and the number of the second physical blocks of the to-be-written data is less than the number of the first physical blocks.

6. The memory system of claim 5, wherein the portion of the dies comprises a first portion of the dies and a second portion of the dies, and the memory controller is configured to:
control, by chip-selecting the first portion of the dies, the memory device to write data to the first physical blocks of the to-be-written data on the first portion of the dies according to addresses of the first physical blocks of the to-be-written data; and
control, by chip-selecting the second portion of the dies, the memory device to write data to the second physical blocks of the to-be-written data on the second portion of the dies according to addresses of the second physical blocks of the to-be-written data.

7. The memory system of claim 5, wherein block addresses in addresses of the first physical blocks of the to-be-written data are different from block addresses in addresses of the second physical blocks of the to-be-written data.

8. The memory system of claim 2, wherein each of the dies further comprises second physical blocks and third physical blocks, and the memory controller is configured to, in response to a third data write instruction, determine first physical blocks of the to-be-written data in the first physical blocks, determine second physical blocks of the to-be-written data in the second physical blocks, and determine third physical blocks of the to-be-written data in the third physical blocks, and wherein a sum of the number of the first physical blocks of the to-be-written data, the number of the second physical blocks of the to-be-written data, and the number of the third physical blocks of the to-be-written data is less than the number of the first physical blocks.

9. The memory system of claim 8, wherein the portion of the dies comprises a first portion of the dies, a second portion of the dies and a third portion of the dies, and the memory controller is configured to:
control, by chip-selecting the first portion of the dies, the memory device to write data to the first physical blocks of the to-be-written data on the first portion of the dies according to addresses of the first physical blocks of the to-be-written data;
control, by chip-selecting the second portion of the dies, the memory device to write data to the second physical blocks of the to-be-written data on the second portion of the dies according to addresses of the second physical blocks of the to-be-written data; and
control, by chip-selecting the third portion of the dies, the memory device to write data to the third physical blocks of the to-be-written data on the third portion of the dies according to addresses of the third physical blocks of the to-be-written data.

10. The memory system of claim 8, wherein block addresses in addresses of the first physical blocks of the to-be-written data, block addresses in addresses of the second physical blocks of the to-be-written data, and block addresses in addresses of the third physical blocks of the to-be-written data are different from each other.

11. The memory system of claim 1, wherein block addresses in the addresses of the physical blocks of the to-be-written data are the same, or wherein block addresses in addresses of physical blocks of a portion of the to-be-written data are different from block addresses in addresses of physical blocks of the other to-be-written data.

12. A method of operating a memory system, wherein the memory system comprises a memory device comprising dies, each of the dies comprises first physical blocks, and the method comprises:
in response to a data write instruction, determining physical blocks of to-be-written data, wherein a number of the physical blocks of the to-be-written data is less than the number of the first physical blocks; and
controlling the memory device to write data to the physical blocks of the to-be-written data according to addresses of the physical blocks of the to-be-written data.

13. The method of claim 12, wherein the physical blocks of the to-be-written data are located on a portion of the dies.

14. The method of claim 13, wherein in response to a data write instruction, determining physical blocks of to-be-written data comprises, in response to a first data write instruction, determining first physical blocks of the to-be-written data in the first physical blocks, and wherein the number of the first physical blocks of the to-be-written data is less than the number of the first physical blocks.

15. The method of claim 14, wherein controlling the memory device to write data to the physical blocks of the to-be-written data according to addresses of the physical blocks of the to-be-written data comprises controlling, by chip-selecting the portion of the dies, the memory device to write data to the first physical blocks of the to-be-written data on the portion of the dies according to addresses of the first physical blocks of the to-be-written data.

16. The method of claim 13, wherein each of the dies further comprises second physical blocks, and in response to a data write instruction, determining physical blocks of to-be-written data comprises, in response to a second data write instruction, determining first physical blocks of the to-be-written data in the first physical blocks, and determining second physical blocks of the to-be-written data in the second physical blocks, and wherein a sum of the number of the first physical blocks of the to-be-written data and the number of the second physical blocks of the to-be-written data is less than the number of the first physical blocks.

17. The method of claim 16, wherein the portion of the dies comprises a first portion of the dies and a second portion of the dies, and controlling the memory device to write data to the physical blocks of the to-be-written data according to addresses of the physical blocks of the to-be-written data comprises:
controlling, by chip-selecting the first portion of the dies, the memory device to write data to the first physical blocks of the to-be-written data on the first portion of the dies according to addresses of the first physical blocks of the to-be-written data; and
controlling, by chip-selecting the second portion of the dies, the memory device to write data to the second physical blocks of the to-be-written data on the second portion of the dies according to addresses of the second physical blocks of the to-be-written data.

18. The method of claim 16, wherein block addresses in addresses of the first physical blocks of the to-be-written data are different from block addresses in addresses of the second physical blocks of the to-be-written data.

19. The method of claim 13, wherein each of the dies further comprises second physical blocks and third physical blocks, and in response to a data write instruction, determining physical blocks of the to-be-written data comprises, in response to a third data write instruction, determining first physical blocks of the to-be-written data in the first physical blocks, determining second physical blocks of the to-be-written data in the second physical blocks, and determining third physical blocks of the to-be-written data in the third physical blocks, and wherein a sum of the number of the first physical blocks of the to-be-written data, the number of the second physical blocks of the to-be-written data, and the number of the third physical blocks of the to-be-written data is less than the number of the first physical blocks.

20. A memory controller, comprising:
a first interface circuit;
a second interface circuit; and
a processing circuit coupled to the first interface circuit and the second interface circuit and configured to:
receive, by the first interface circuit, a data write instruction;
in response to the data write instruction, control, by the second interface circuit, a memory device to write data to physical blocks of to-be-written data, wherein the memory device comprises dies, each of the dies comprises first physical blocks, and a number of the physical blocks of the to-be-written data is less than a number of the first physical blocks.
